(19) United States
(12) Patent Application Publication
(10) Pub. No.: US 2022/0350500 A1
(43) Pub. Date: Nov. 3, 2022

(54) EMBEDDED CONTROLLER AND MEMORY TO STORE MEMORY ERROR INFORMATION

(71) Applicant: Intel Corporation, Santa Clara, CA (US)

(72) Inventors: Wei P. CHEN, Portland, OR (US); Theodros YIGZAW, Sherwood, OR (US); Sarathy JAYAKUMAR, Portland, OR (US); Anthony LUCK, San Jose, CA (US); Deep K. BUCH, Folsom, CA (US); Rajat AGARWAL, Portland, OR (US); Kuljit S. BAINS, Olympia, WA (US); John G. HOLM, Beaverton, OR (US); Brent CHARTRAND, Folsom, CA (US); Keith KLAYMAN, Folsom, CA (US)

(21) Appl. No.: 17/855,688

(22) Filed: Jun. 30, 2022

(51) Int. Cl. G06F 3/06

(52) U.S. Cl. CPC G06F 3/0619; G06F 3/0655; G06F 3/0673

(57) ABSTRACT

An apparatus is described. The apparatus includes a processor. The processor includes a memory controller to read and write from a memory. The memory controller includes error correction coding (ECC) circuitry to correct errors in data read from the memory. The processor includes register space to track read data error information. The processor includes an embedded controller. The processor includes local memory coupled to the embedded controller. The embedded controller is to read the read data error information and store the read data error information in the local memory.

### FIELD OF INVENTION

The field of invention pertains to generally to the computer science arts, and, more specifically, to an embedded controller and memory to store memory error information.

### BACKGROUND

The reliability of information stored in semiconductor memory chips continues to deteriorate as memory chip storage cell size continues to shrink. System designers are therefore seeking ways to improve the monitoring of the memory errors that occur within their systems so that catastrophic memory related failures can be avoided.

### FIGURES

FIG. 1a shows a traditional memory error correction monitoring architecture (prior art);

FIG. 1b shows another memory error correction monitoring architecture;

FIG. 2 shows an embodiment of an improved memory error correction monitoring architecture;

FIG. 3 shows an embodiment of a method performed by the improved memory error correction monitoring architecture;

FIG. 4 shows an embodiment of memory read data error information that can be recorded by the improved memory error correction monitoring architecture of FIG. 2;

FIG. 5 shows a system;

FIG. 6 shows a data center;

FIG. 7 shows a rack.

### DETAILED DESCRIPTION

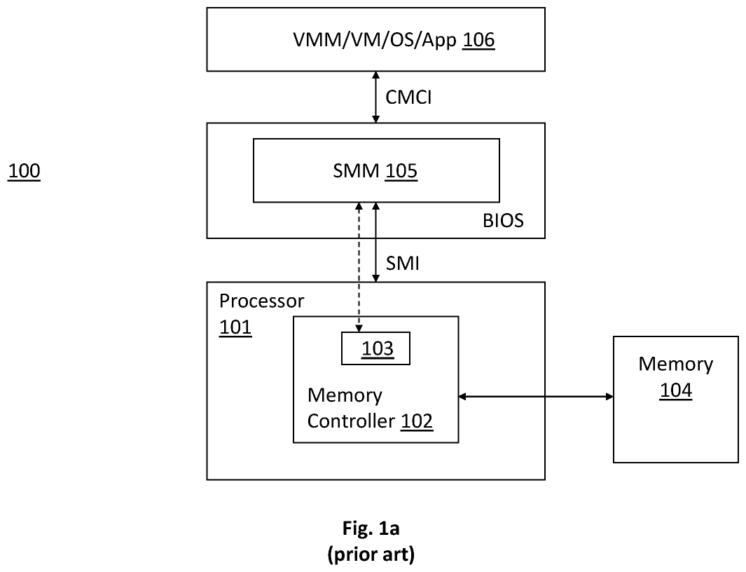

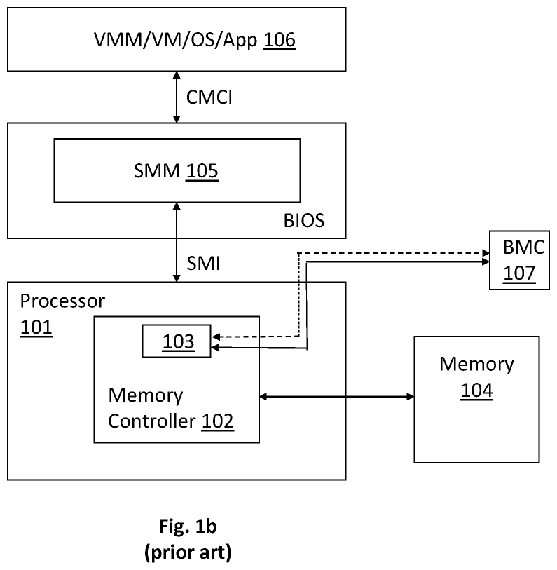

FIG. 1a shows a traditional architecture for monitoring a computer system's memory performance. As observed in FIG. a1, the hardware, such as a general purpose multi-core processor 101 includes a memory controller 102 that is coupled to a memory 103 (e.g., a dynamic random access memory (DRAM) system memory). During runtime of the computer, the memory can be prone to errors. That is, the data that the memory controller 102 reads from a particular memory address is different than the data that the memory controller 102 earlier wrote to that same address.

The memory controller 102 therefore includes error correction code (ECC) logic (not shown) that calculates ECC information from data to be written into memory 104 and then stores the ECC information along with the data in memory 104 as part of the data's write operation. Upon a subsequent read of that same data, if there is an error in the data, the memory controller's ECC logic processes the data and the ECC information together to correct errors in the data, if any, if possible (most ECC algorithms are only capable of correcting one or two errors per read operation).

Additionally, the computer system typically includes spare memory space within one or more memory chips and/or one or more spare memory chips so that, if a particular memory region is degrading, its content can be “switched over” to the spare memory space. Even further, many computer systems configure the memory controller to perform “memory mirroring” in which redundant copies of data items are stored in memory 104 so that data can be recovered from its redundant copy if its main version suffers an uncorrectable error.

A sign of a degrading memory is more frequent reliance on ECC error correction and/or “switchover” events to spare memory space or redundant data items. The processor 101 therefore includes register space 103 that tracks statistics and/or events concerning the above described memory reliability protection schemes.

For example, register space 103 tracks ECC related statistics for nominal runtime in which CPU cores on the processor 101 issue memory read requests to the memory controller 102. The register space 103 includes: 1) a first timestamp of a first read in which an ECC was detected; 2) a second timestamp of the most recent read in which an ECC error was detected; 3) whether the error recorded in 2) was correctible or uncorrectable with the ECC; 4) the address and memory channel of the read recorded in 2); 5) a count of the total number of reads between the first and second timestamps in which an ECC error was detected; and, 6) a programmable threshold. The system address, memory channel ID, memory module ID, memory chip ID and/or other information that identifies the failing channel, module and/or chip is also recorded for the read operation of the most recent ECC error referred to in register 2) above.

In certain processors the memory controller 102 can also proactively and periodically read the memory's contents to assess memory reliability. Here, e.g., as a background process that is performed in between the servicing of memory access requests received from the CPU cores, the memory controller 102 scrolls through the memory's address space (“polls the memory”), performs reads from the addresses and accesses how frequently ECC is relied upon to obtain valid data. Another set of registers 1)-6) described just above for CPU read requests are also maintained for the background polling process.

For either of the CPU read requests or the background polling, if the total number of ECC errors in register space 5) surpasses the programmable threshold set in register space 6), or if register space 3) indicates an uncorrectable error, the processor hardware communicates a system management interrupt (SMI) to the computer's system management mode (SMM) firmware 105. The SMM 105 is an inner layer of program code that executes beneath the computer's higher layers of software 106 which commonly include a virtual machine monitor (VMM), virtual machine(s) (VM(s)), operating system (OS) instances and application software instances. Generally, these higher software layers 106 have little or no visibility into SMM operations.

In response to the SMI, the SMM 105 reads the memory reliability registers 103, stores the register content in tabular information in memory 104 so it is accessible to one or more of the higher layers of software 106 (hereinafter, “the higher software layers” and the like), and, clears the contents of the registers 103 to start a new memory error monitoring cycle within the memory controller 102.

The SMM 105 also generates an interrupt to one or more of the higher layers of software 106 (particularly, the SMM 105 issues a Corrected Machine Check Interrupt (CMCI) to the software 106 if the most recent error was correctable). The higher layers of software 106 can subsequently access the tabular information and take corrective action (e.g., any proscribed reliability, availability and serviceability (RAS) flows (e.g., memory page retirement)). If any errors are not correctable, the processor 101 generates an SMI interrupt to the SMM 105 and, in response, the SMM 105 generates a machine check exception (MCE) to the higher layers of software 106.

The SMM 105 can also periodically poll the content of the memory reliability registers 103 and record their content in memory 104 so that it can be observed to the higher level software.

Regardless, traditionally, the SMM 105 is intricately involved in the reporting of memory reliability information to the upper layer(s) of software 106. Unfortunately, the reliance on the SMM 105 results in the upper layers of software 106 receiving too little information too infrequently. More specifically, because the SMM's accessing of the memory reliability registers 103 interrupts nominal processor operation (e.g., the CPU processing cores are stalled until the register information is read and recorded to memory 104), only large thresholds can realistically be entered in register 6) described above.

Here, whereas legacy computer systems with older memory technologies could set low thresholds because memory errors where relatively infrequent, by contrast, in modern systems, owing to ever-shrinking storage cell feature sizes, memory capacity is much larger and the probability of an error per memory cell is much larger. As a consequence, memory errors are much more frequent in modern systems than in older systems. Invoking the SMM 105 with every memory error (or every few memory errors) is not realistic in modern systems because the SMM 105 would be constantly/chronically invoked resulting in severely disrupted processor 101 operation.

As such, to reduce the frequency of SMM invocations in response to memory errors, large thresholds are set in register 6). Unfortunately, when the large threshold is reached, and the register content is reported out to memory 104 for analysis by the higher level software 106, little can be gleaned from the information (e.g., only the time needed to reach the threshold, whether the most recent error was correctible or not and the system address of the corresponding read operation). As such, the higher level software 106 is less able to anticipate and/or monitor memory degradation and take suitable corrective action well before such degradation threatens system operation and/or mission critical data.

Ideally, the higher level software 106 is able to track memory failures much more closely (e.g., every error is logged or every few errors are logged). The polling capability of the SMM cannot address the problem because capturing memory errors with finer granularity requires more frequent SMM polling which, in turn, translates into nominal processor operation being interrupted too frequently.

FIG. 1b shows another prior art approach that imposes a motherboard controller (BMC) 107 to remove the dependency on the SMM 105 for accessing the memory reliability register space 103. Here, one or more multi-core processor chips are disposed on a system motherboard with associated memory. The motherboard also includes a motherboard controller 107 to provide higher level functions such as system bring-up, shut down, power management, etc.

In the approach of FIG. 1b, the motherboard controller 107 is additionally tasked with polling the memory reliability registers 103 and recording their contents in memory 104. Here, the accesses to the registers 103 made by the motherboard controller 107 do not interfere with the processor's nominal runtime behavior to the extent that SMM accesses do, which, in turn, allows for more frequent readouts of the processor's register content.

Unfortunately, the hardware paths used to access the processor's internal registers (e.g., a control bus between the processor 101 and the motherboard controller 107 and the processor's internal path(s) to/from the registers) are designed mainly for early system bring-up rather than runtime telemetry. As a consequence, the propagation delays associated with the motherboard controller 107 accesses (e.g., in the tens or hundreds of milliseconds) do not provide for suitable low threshold settings or sufficiently frequent polling of the registers 103. Thus, the information that is gathered by the motherboard controller 107 remains coarse grained (too many memory errors occur in between report outs).

Moreover, whereas the processor 100 is natively designed to raise interrupts to the SMM 105 in the case of certain memory reliability events, by contrast, the processor is not able to send an interrupt to the motherboard controller 107 for at least some of these events (e.g., a redundant switchover event).

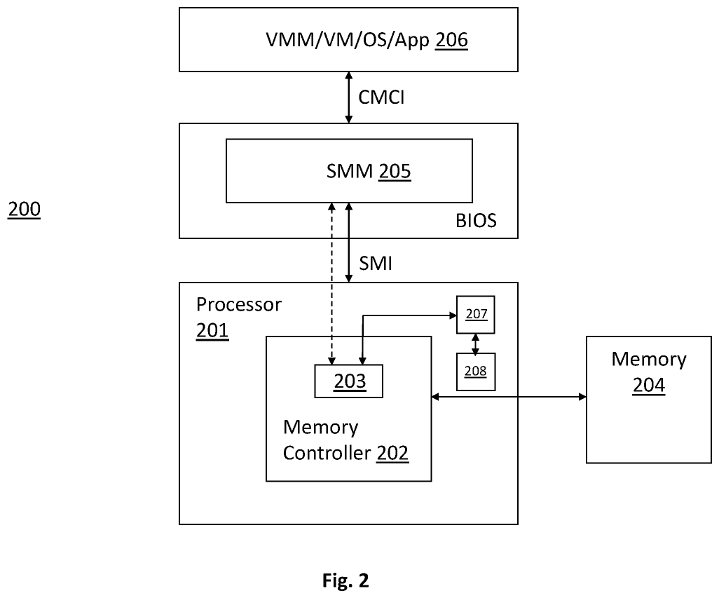

FIG. 2 shows an improved approach that integrates a micro-controller 207 (also referred to as an embedded controller) with its own local memory 208 (e.g. SRAM or embedded DRAM) within the processor. In various embodiments, a main function of the micro-controller 207 is to frequently access the memory reliability registers 203 (whether through polling or responsive to interrupts), record additional reliability information beyond what is found in the register space 203 (e.g., supply voltages, die temperatures, etc.) and store the corpus of information into the local memory 208.

Here, the micro-controller 207 is communicatively coupled to the register space 203 by way of a high speed internal link or bus within the processor 200 that allows the micro-controller 207 to quickly access the registers 203 in response to interrupts or other flags that are sent to the micro-controller 207 by the processor 201 in view of a memory reliability event, and/or, poll the registers 203 with great rapidity. In various embodiments the local memory 208 is large enough and fast enough to store the memory reliability information from multiple micro-controller 207 accessing and storing cycles.

As such, the micro-controller can respond to interrupts caused by very low programmable thresholds (e.g., a setting of 1, any number between 1 and 10, 10, a number in the 10s, etc.) and/or poll the register content 203 at very high frequencies. In the case of the former, for example, a programmable threshold is set such that an interrupt is generated every few ECC errors or every single ECC error.

Setting such low thresholds causes memory reliability interrupts/flags to be sent to the micro-controller at a high rate (e.g., in some timespans, interrupts are generated every few microseconds, tens of microseconds, etc.). The micro-controller 207, the link/bus between the micro-controller 207 and the register space 203, and the local memory 208 all have the bandwidth/throughput to access and record the memory reliability information and keep pace with such a high rate of interrupts/flags. Alternatively, the micro-processor can be programmed to poll the memory reliability information at a correspondingly fast rate (e.g., every few microseconds, ten microseconds, tens of microseconds, etc.). The additional information (e.g., voltages, temperatures) can also be rapidly obtained through similarly fast hardware circuitry.

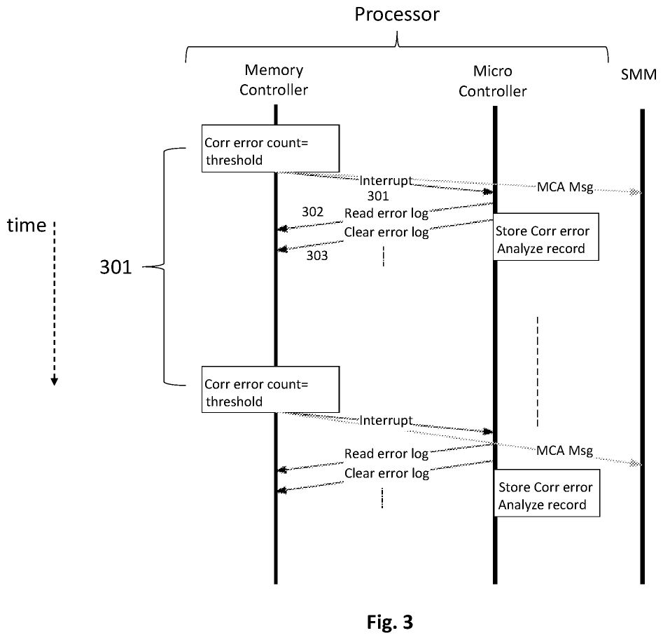

FIG. 3 shows a high level view of a process that can be executed within a processor having a micro-controller 207 as described at length above. As observed in FIG. 3, within (or associated with) the memory controller 202, a programmable threshold is set to a low level (e.g., 1). A separate counter counts memory reads in the current monitoring cycle in which an ECC error was detected. When the counter reaches the threshold the memory controller 202 sends an interrupt 301 to the micro-controller.

In response, the micro-controller 207 accesses 302 the registers 203 directed to memory reliability (such as registers 1)-6) described above with respect to FIG. 1) and any additional information depending on the embodiment (e.g., any/all of memory channel voltage, memory module voltage, memory chip voltage, memory module temperature, memory chip temperature, ambient motherboard temperature, etc.). The micro-controller 202 records the register content (e.g., including any/all of the information described above with respect to registers 1) - 6)) and the additional information (if any) to the local memory 208.

The micro-controller 207 then clears 303 the registers 203 to initiate a new memory monitoring cycle and begins processing the newly recorded information in the local memory 208. After the information is processed (described in more detail further below), the processed information is reported out of the local memory 208 to other memory space (e.g., in system memory that is visible to the upper layers of software). An optional machine check architecture (MCA) interrupt can be issued by the processor to the higher level software with each interrupt sent to the micro-controller (e.g., a CMCI in the case of a correctable error or a machine check exception (MCE) in the case of an uncorrectable error).

Here, program code executing on the micro-controller 207 can be written to perform any/all of the above described micro-controller 207 functions. Alternatively or in combination, the micro-controller 207 can be hardwired (e.g., as a state machine circuit) to perform some/all of these functions in dedicated specific hardware logic rather than through (e.g., slower) code execution.

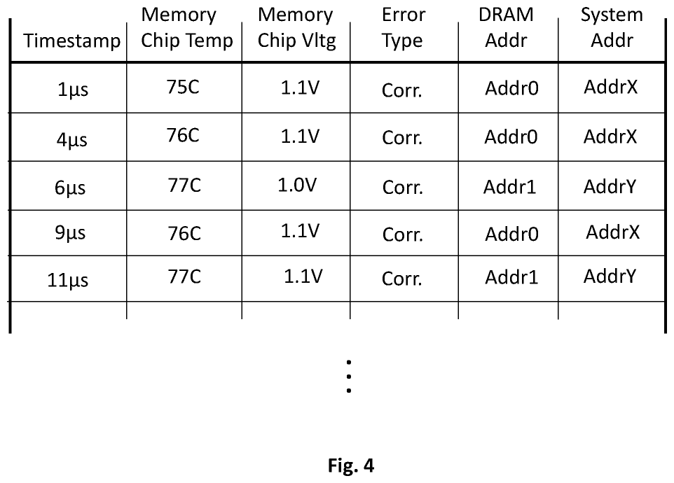

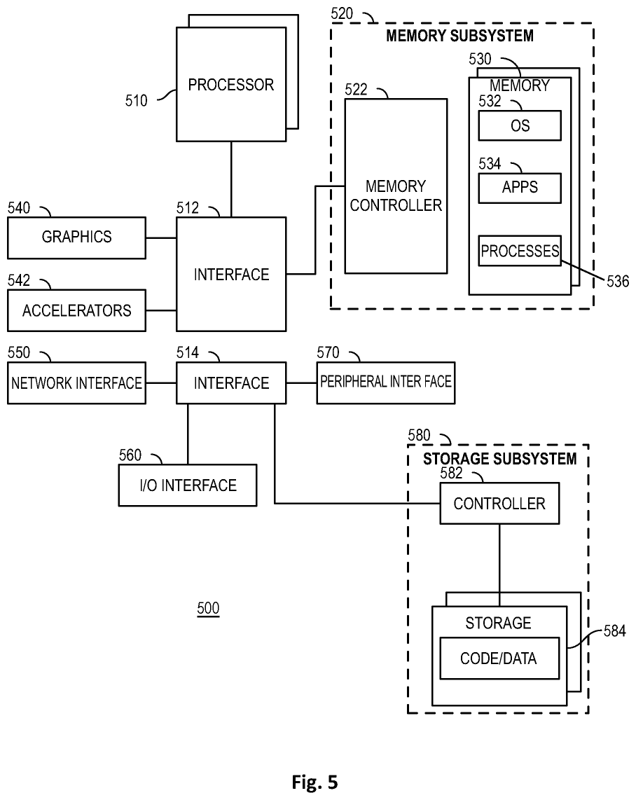

With respect to the collection 302 and processing of the raw data, FIG. 4 shows an exemplary embodiment of the tabularized information as structured, e.g., for presentation to higher software level(s) in memory 204, after processing by the micro-controller 207. As observed in FIG. 4, the information is organized such that each row corresponds to a different moment in time when a particular access of the memory reliability information was taken. In the example of FIG. 5, the threshold is set to 1 so that every detected ECC error generates an interrupt and information read-out.

As observed in FIG. 4, the detected errors occur at various times (as reflected by the timestamps in the first column). For each detected error the micro-controller 207 collects whether the error was correctable or not and addressing information that identifies the particular address and memory chip that suffered the error. This information, in various embodiments, is fetched from internal register space within the processor. The micro-controller also collects additional information, e.g., outside the processor chip. Specifically, the micro-controller 207 collects the temperature of the memory chip that suffered the failure and the supply voltage of the memory module where the memory chip resides.

The former (temperature of memory chip) can be accomplished by the micro-controller 207 sending a command to the memory controller 202 to read mode register (MR) space that exists in the memory chip. Here, for example, Joint Electron Device Engineering Council (JEDEC) memory chip specifications define requirements for certain mode registers on JEDEC compliant memory chips. Such requirements can include the temperature of a memory chip (e.g., the memory chip has an internal thermistor whose temperature reading is reported to a particular MR location).

JEDEC also describes communication protocols between a memory controller and memory chip for reading the MR content over the memory channel that couples the memory controller to the memory module that the memory chip is a component of Thus, to collect the memory chip temperature, as part of the collection of information responsive to an ECC interrupt, the micro-controller 207 sends a command to the memory controller 202 to implement such protocols on the JEDEC memory channel that the failing memory chip is coupled to. After reading the temperature from the memory chip, the memory controller 202 reports the temperature to the micro-controller 207. The micro-controller 207, in turn, inserts it into the correct location in the tabular information. A similar process can also occur with the memory chip's supply voltage.

Alternatively or in combination, the micro-controller 207 can seek memory module temperature/voltage information. Here, the failing memory chip can be a component on a memory module (e.g., dual in-line memory module (DIMM), stacked memory module (e.g., JEDEC High Bandwidth Memory (HBM) module), etc.) having, e.g., a power management integrated circuit (PMIC) having readable register space that contains the temperature of the module (e.g., its ambient, a weighted average of its various chips, etc.) and/or the supply voltage(s) that are being supplied to the memory chips on the module. Again, the memory controller is designed to include JEDEC or other defined protocols for reading such, e.g., PMIC register space. The micro-controller therefore sends a command to the memory controller to perform the specific PMIC read. The memory controller reports the read data to the micro-controller which places it in the correct location in the organized data structure.

In still other or combined embodiments, temperatures and/or voltages other than those on a memory chip or memory module can be collected by the micro-controller 207. For temperatures/voltages that are on the processor die, the micro-controller 207 can collect the information directly from the appropriate registers on the processor die.

For other temperatures/voltages that are external to the processor (such as the temperature of the motherboard's ambient, or the motherboard's supply voltage), the micro-controller can cause the appropriate register or memory space of some external component (e.g., the motherboard's power management integrated circuit (PMIC)) to be read and reported to the micro-controller 207. According to a first approach a direct sideband communication channel exists between the micro-controller 207 and the external component (e.g., an I2C bus between the micro-controller and the motherboard PMIC). According to a second approach the micro-controller 207 leverages a control bus that exists between the processor and the external component (e.g., the micro-controller uses an I2C bus that is coupled between the processor, the motherboard PMIC and other components on the motherboard).

In cases where the micro-controller 207 periodically polls the memory reliability information without an actual error/interrupt triggering the information collection activity, the organization can be like that listed in FIG. 4, except that the timestamp of each row reflects the periodicity of the polling rather than the actual occurrence of an error. Here, an extra column can be added that records the content of the ECC error detection count. With polling, it is possible that no new errors occurred between consecutive collections of memory reliability information.

How much tabular information can be included in the local memory 208 depends on the size of the local memory 208. In various embodiments, the tabular information is written to the local memory 208 as a circular buffer in which older information is continually written over with newer information. Higher level software 206 can be programmed to read the entries in the local memory 208 before they are written over, and/or, the micro-controller 207 can cause the entries to be written to memory space outside the processor (e.g., memory 204) where they can be accessed by the software 206.

In further embodiments, the functionality of the micro-controller 207 is enhanced to include RAS flows that take corrective action in response to the memory failure information. Examples include imposing any of: 1) persistent error with bounded fault; 2) persistent error in row; 3) persistent error in bank; 4) switchover to mirrored/redundancy memory; 5) memory page retirement.

In the case of persistent error with bounded fault, certain memory read addresses are consistently yielding ECC errors. Here, spare memory space can be used to take the place of the address space that is yielding the errors. Persistent error in row is similar to persistent error with bounded fault but the failing addresses can be resolved to a particular row within a memory chip. Here, the memory chip has spare rows that the memory chip can be configured to use to replace the bad row.

Persistent error in bank is like persistent error in row except that the failing addresses can be resolved to a particular bank within a memory chip. Here, the memory chip has spare banks that the memory chip can be commanded to use to replace the bad bank.

Commonly, these corrections are implemented based on correctable ECC errors so that the bad memory space is replaced before it begins to yield uncorrectable memory errors.

In the case of a switchover to mirrored/redundant memory, primary memory space (e.g., a memory channel, a memory module, a portion of a memory module, etc.) is shut down and its corresponding mirrored/redundant memory space is used instead. A mirrored/redundant switchover is typically performed in response to uncorrectable error(s) (but can also be performed in response to correctable errors).

For any of these corrective actions, in various embodiments, the micro-controller 207 commands the memory controller 202 to effect these corrective actions, e.g., over the memory channel between the memory chip's module and the memory controller and according to some predefined (e.g., JEDEC) protocol.

In the case of memory page retirement, typically, un uncorrectable error occurs on a memory page. Here, the micro-controller 207 observes the uncorrectable error and causes the processor to triggers a machine check exception (MCE) (e.g., with read address information) to the SMM as per traditional uncorrectable memory errors. Higher layer software 206 can then retire the page having the address with the uncorrectable error.

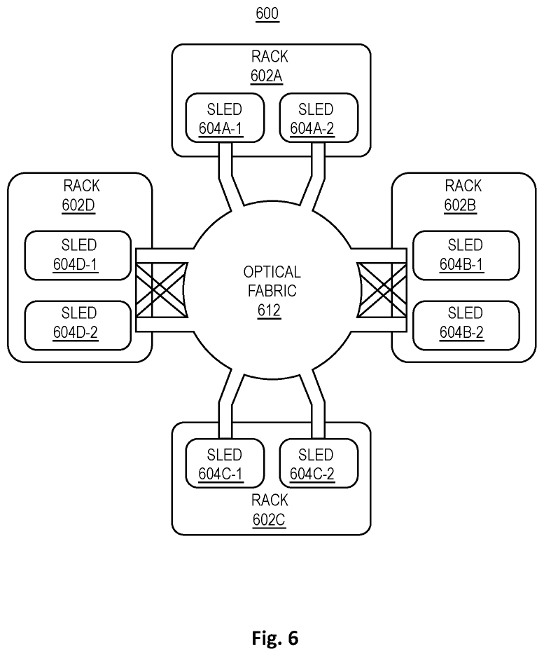

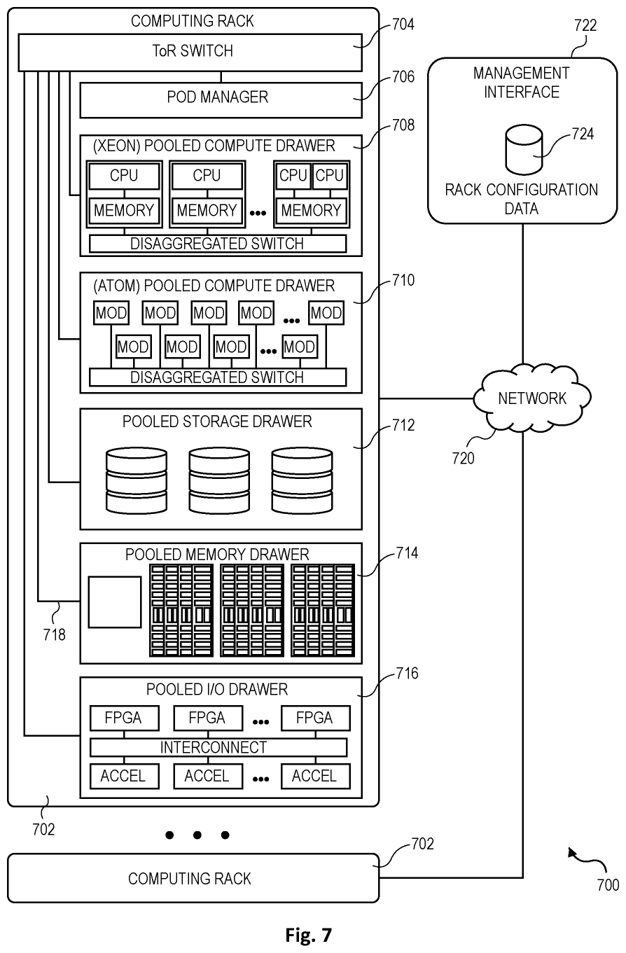

The following discussion concerning FIGS. 5, 6, and 7 are directed to systems, data centers and rack implementations, generally. FIG. 5 generally describes possible features of an electronic system that can include a micro-controller and local memory as described above. FIG. 6 describes possible features of a data center that can include such electronic systems. FIG. 7 describes possible features of a rack having one or more such electronic systems installed into it.

FIG. 5 depicts an example system. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Certain systems also perform networking functions (e.g., packet header processing functions such as, to name a few, next nodal hop lookup, priority/flow lookup with corresponding queue entry, etc.), as a side function, or, as a point of emphasis (e.g., a networking switch or router). Such systems can include one or more network processors to perform such networking functions (e.g., in a pipelined fashion or otherwise).

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a fixed function offload engine that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), “X” processing units (XPUs), programmable control logic circuitry, and programmable processing elements such as field programmable gate arrays (FPGAs). Accelerators 542, processor cores, or graphics processing units can be made available for use by artificial intelligence (AI) or machine learning (ML) models. For example, the AI model can use or include any or a combination of a reinforcement learning scheme, Q-learning scheme, deep-Q learning, or Asynchronous Advantage Actor-Critic (A3C), convolutional neural network, recurrent convolutional neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, volatile memory, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software functionality to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510. In some examples, a system on chip (SOC or SoC) combines into one SoC package one or more of: processors, graphics, memory, memory controller, and Input/Output (I/0) control logic circuitry.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on June 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WI02 (Wide Input/Output version 2, JESD229-2 originally published by JEDEC in August 2014, HBM (High Bandwidth Memory), JESD235, originally published by JEDEC in October 2013, LPDDRS, HBM2 (HBM version 2), or others or combinations of memory technologies, and technologies based on derivatives or extensions of such specifications.

In various implementations, memory resources can be “pooled”. For example, the memory resources of memory modules installed on multiple cards, blades, systems, etc. (e.g., that are inserted into one or more racks) are made available as additional main memory capacity to CPUs and/or servers that need and/or request it. In such implementations, the primary purpose of the cards/blades/systems is to provide such additional main memory capacity. The cards/blades/systems are reachable to the CPUs/servers that use the memory resources through some kind of network infrastructure such as CXL, CAPI, etc.

The memory resources can also be tiered (different access times are attributed to different regions of memory), disaggregated (memory is a separate (e.g., rack pluggable) unit that is accessible to separate (e.g., rack pluggable) CPU units), and/or remote (e.g., memory is accessible over a network).

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a HyperTransport or industry standard architecture (ISA) bus, a small computer system interface (SCSI) bus, Remote Direct Memory Access (RDMA), Internet Small Computer Systems Interface (iSCSI), NVM express (NVMe), Coherent Accelerator Interface (CXL), Coherent Accelerator Processor Interface (CAPI), Cache Coherent Interconnect for Accelerators (CCIX), Open Coherent Accelerator Processor (Open CAPI) or other specification developed by the Gen-z consortium, a universal serial bus (USB), or an Institute of Electrical and Electronics Engineers (IEEE) standard 1394 bus.

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a remote device, which can include sending data stored in memory. Network interface 550 can receive data from a remote device, which can include storing received data into memory. Various embodiments can be used in connection with network interface 550, processor 510, and memory subsystem 520.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits in both processor 510 and interface 514.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base, and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented as a disaggregated computing system. For example, the system 500 can be implemented with interconnected compute sleds of processors, memories, storages, network interfaces, and other components. High speed interconnects can be used such as PCIe, Ethernet, or optical interconnects (or a combination thereof). For example, the sleds can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Although a computer is largely described by the above discussion of FIG. 5, other types of systems to which the above described invention can be applied and are also partially or wholly described by FIG. 5 are communication systems such as routers, switches, and base stations.

FIG. 6 depicts an example of a data center. Various embodiments can be used in or with the data center of FIG. 6. As shown in FIG. 6, data center 600 may include an optical fabric 612. Optical fabric 612 may generally include a combination of optical signaling media (such as optical cabling) and optical switching infrastructure via which any particular sled in data center 600 can send signals to (and receive signals from) the other sleds in data center 600. However, optical, wireless, and/or electrical signals can be transmitted using fabric 612. The signaling connectivity that optical fabric 612 provides to any given sled may include connectivity both to other sleds in a same rack and sleds in other racks.

Data center 600 includes four racks 602A to 602D and racks 602A to 602D house respective pairs of sleds 604A-1 and 604A-2, 604B-1 and 604B-2, 604C-1 and 604C-2, and 604D-1 and 604D-2. Thus, in this example, data center 600 includes a total of eight sleds. Optical fabric 612 can provide sled signaling connectivity with one or more of the seven other sleds. For example, via optical fabric 612, sled 604A-1 in rack 602A may possess signaling connectivity with sled 604A-2 in rack 602A, as well as the six other sleds 604B-1, 604B-2, 604C-1, 604C-2, 604D-1, and 604D-2 that are distributed among the other racks 602B, 602C, and 602D of data center 600. The embodiments are not limited to this example. For example, fabric 612 can provide optical and/or electrical signaling.

FIG. 7 depicts an environment 700 that includes multiple computing racks 702, each including a Top of Rack (ToR) switch 704, a pod manager 706, and a plurality of pooled system drawers. Generally, the pooled system drawers may include pooled compute drawers and pooled storage drawers to, e.g., effect a disaggregated computing system. Optionally, the pooled system drawers may also include pooled memory drawers and pooled Input/Output (I/O) drawers. In the illustrated embodiment the pooled system drawers include an INTEL® XEON® pooled computer drawer 708, and INTEL® ATOMTM pooled compute drawer 710, a pooled storage drawer 712, a pooled memory drawer 714, and a pooled I/O drawer 716. Each of the pooled system drawers is connected to ToR switch 704 via a high-speed link 718, such as a 40 Gigabit/second (Gb/s) or 100 Gb/s Ethernet link or an 100+ Gb/s Silicon Photonics (SiPh) optical link. In one embodiment high-speed link 718 comprises an 600 Gb/s SiPh optical link.

Again, the drawers can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Multiple of the computing racks 700 may be interconnected via their ToR switches 704 (e.g., to a pod-level switch or data center switch), as illustrated by connections to a network 720. In some embodiments, groups of computing racks 702 are managed as separate pods via pod manager(s) 706. In one embodiment, a single pod manager is used to manage all of the racks in the pod. Alternatively, distributed pod managers may be used for pod management operations. RSD environment 700 further includes a management interface 722 that is used to manage various aspects of the RSD environment. This includes managing rack configuration, with corresponding parameters stored as rack configuration data 724.

Any of the systems, data centers or racks discussed above, apart from being integrated in a typical data center, can also be implemented in other environments such as within a bay station, or other micro-data center, e.g., at the edge of a network.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation.

Some examples may be implemented using or as an article of manufacture or at least one computer-readable medium. A computer-readable medium may include a non-transitory storage medium to store program code. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the program code implements various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled, and/or interpreted programming language.

To the extent any of the teachings above can be embodied in a semiconductor chip, a description of a circuit design of the semiconductor chip for eventual targeting toward a semiconductor manufacturing process can take the form of various formats such as a (e.g., VHDL or Verilog) register transfer level (RTL) circuit description, a gate level circuit description, a transistor level circuit description or mask description or various combinations thereof. Such circuit descriptions, sometimes referred to as “IP Cores”, are commonly embodied on one or more computer readable storage media (such as one or more CD-ROMs or other type of storage technology) and provided to and/or otherwise processed by and/or for a circuit design synthesis tool and/or mask generation tool. Such circuit descriptions may also be embedded with program code to be processed by a computer that implements the circuit design synthesis tool and/or mask generation tool.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software, and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences may also be performed according to alternative embodiments. Furthermore, additional sequences may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

1. An apparatus, comprising:
a processor comprising: i), ii), iii) and iv) below:
i) a memory controller to read from and write to a memory, the memory controller comprising error correction coding (ECC) circuitry to correct errors in data read from the memory;
ii) register space to store read data error information;
iii) an embedded controller; and,
iv) a local memory coupled to the embedded controller, the embedded controller to read the read data error information and store the read data information in the local memory.

2. The apparatus of claim 1 wherein the embedded controller is able to store timestamps of consecutive ones of the read data errors in the local memory.

3. The apparatus of claim 1 wherein the embedded controller is able to read the read data error information in response to an interrupt generated from the read data error information.

4. The apparatus of claim 1 wherein the embedded controller is able to periodically read the read data error information.

5. The apparatus of claim 1 wherein the read data error information comprises a timestamp of a read data error.

6. The apparatus of claim 1 wherein the embedded controller is to store a voltage associated with a read data error in the local memory.

7. The apparatus of claim 1 wherein the embedded controller is to store a temperature associated with a read data error in the local memory.

8. A machine readable storage medium containing program code that when processed by an embedded controller on a processor causes the embedded controller to perform a method, comprising:
receiving an interrupt, the interrupt generated because of a memory read error;
reading register space that tracks memory read error information; and,
writing the memory read error information in memory on the processor.

9. The machine readable storage medium of claim 8 wherein the method further comprises the embedded controller writing a temperature associated with the memory read error in the memory.

10. The machine readable storage medium of claim 8 wherein the method further comprises the embedded controller writing a voltage associated with the memory read error in the memory.

11. The machine readable storage medium of claim 8 wherein the memory read error information comprises a timestamp of the memory read error.

12. The machine readable storage medium of claim 11 wherein the method further comprises writing a timestamp of a next memory read error in the memory.

13. The machine readable storage medium of claim 8 wherein the method further comprises the embedded controller causing the memory read error information to be transferred from the memory of the processor to a second memory that is external from the processor.

14. A computing system, comprising:
a memory module; and,
a processor comprising a plurality of processing cores, a memory controller, register space, an embedded controller and a local memory, the memory controller coupled to the memory module, the memory controller to read from and write to the memory module, the register space to store read data error information, the embedded controller to read the read data error information and store the read data error information in the local memory.

15. The computing system of claim 14 wherein the embedded controller is able to store timestamps of consecutive ones of the read data errors in the local memory.

16. The computing system of claim 14 wherein the embedded controller is able to read the read data error information in response to an interrupt generated from the read data error information.

17. The computing system of claim 14 wherein the embedded controller is able to periodically read the read data error information.

18. The computing system of claim 14 wherein the read data error information comprises a timestamp of a read data error.

19. The computing system of claim 14 wherein the embedded controller is to store a voltage associated with a read data error in the local memory.

20. The computing system of claim 14 wherein the embedded controller is to store a temperature associated with a read data error in the local memory.
